(19) United States
(12) Patent Application Publication
(10) Pub. No.: US 2009/0251043 A1
(43) Pub. Date: Oct. 8, 2009

(54) Coatings for Spacers in Emission Displays

(76) Inventors: James Francis Edwards, Lancaster, PA (US); Peter Michael Ritt, East Petersburg, PA (US)

Correspondence Address: Thomson Licensing LLC, P.O. Box 5312, Two Independence Way, PRINCETON, NJ, 08543-5312, US

(21) Appl. No.: 12/227,497

(22) PCT Filed: Jun. 28, 2006
(86) PCT No.: PCT/US2006/025229

§ 371 Date: Nov. 19, 2008

(51) Int. Cl. H01J 1/88

(52) U.S. Cl. 313/495; 313/292

(57) ABSTRACT

A resistive spacer coating for a carbon nanotube (CNT)/field emission device (FED) display is described. The resistive spacer coating reduces electrostatic charging of the spacer during operation of the display while maintaining the field potential between the cathode and the phosphor screen. The resistive coating includes one or more resistive materials which are combined with binders that are then applied to the spacer.

### BACKGROUND OF THE INVENTION

1. Field of the Invention

The invention relates to an emission displays and, more particularly to coatings for spacers therein.

2. Description of the Background Art

Carbon nanotube (CNT)/field emission device (FED) displays typically include a cathode with CNT emitters thereon, a metal gate, insulating spacers and a phosphor screen. The insulating spacers are interposed between the cathode and the phosphor screen. The phosphor screen is located on an inner surface of a faceplate of the display. The metal gate functions to direct electron beams generated from the CNT emitters toward appropriate color-emitting phosphors on the screen of the display.

The screen may be a luminescent screen. Luminescent screens typically comprise an array of three different color-emitting phosphors (e.g., green, blue and red) formed thereon. Each of the color-emitting phosphors is separated from another by a matrix line. The matrix lines are typically formed of a light-absorbing black, inert material.

The insulating spacers are used in CNT/FED displays to keep the distance between the cathode and the phosphor screen constant under vacuum. However, the spacers can develop surface electrostatic charges during operation of the display, adversely affecting picture quality. Poor picture quality is a particular concern for CNT/FED displays.

Thus, a need exists for a CNT/FED display with spacers having reduced surface electrostatic charging during operation.

### SUMMARY OF THE INVENTION

The present invention relates to a resistive spacer coating for a carbon nanotube (CNT)/field emission device (FED) display. The resistive spacer coating reduces electrostatic charging of the spacer during operation of the display while maintaining the field potential between the cathode and the phosphor screen. The resistive coating includes one or more resistive materials which are combined with binders that are then applied to the spacer.

### BRIEF DESCRIPTION OF THE DRAWINGS

The invention will now be described in greater detail, with relation to the accompanying drawings, in which:

FIG. 1 is a schematic view of a CNT/FED display, showing a luminescent screen and cathode separated by an insulating spacer.

### DETAILED DESCRIPTION

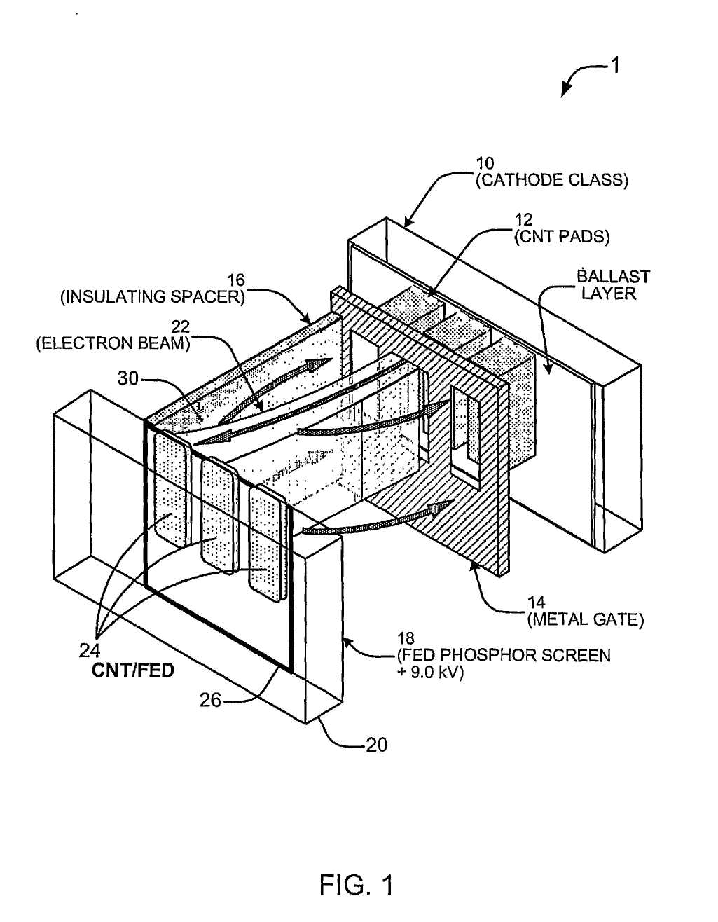

As shown in FIG. 1, a carbon nanotube (CNT)/field emission device (FED) display 1 includes a cathode 10 with CNT emitters 12 thereon, a metal gate 14, insulating spacers 16 and a phosphor screen 18. The insulating spacers 16 (only one spacer is shown in FIG. 1) are interposed between the cathode 10 and the phosphor screen 18. The phosphor screen 18 is located on an inner surface of a faceplate 20 of the display. The metal gate 14 functions to direct electron beams 22 generated from the CNT emitters 12 toward appropriate color-emitting phosphors 24 on the screen 18 of the display 1.

The screen 18 may be a luminescent screen. Luminescent screens typically comprise an array of three different color-emitting phosphors 24 (e.g., green, blue and red) formed thereon. Each of the color-emitting phosphors 24 is separated from another by a matrix 26. The matrix 26 is typically formed of a light-absorbing black, inert material.

The three-color phosphors 24 may include a ZnS:Cu, Al (green) phosphor, a ZnS:Ag, Cl (blue) phosphor and a Y₂O₂S:Eu⁺³ (red) phosphor. This RGB phosphor system is suitable for a carbon nanotube (CNT)/field emission device (FED) display operated between about 4-10 kV.

The insulating spacers 16 are used in CNT/FED displays to keep the distance between the cathode 10 and the phosphor screen 18 constant under vacuum. The insulating spacers 16 may be made for example, of glass. The insulating spacers 16 have a resistive coating 30 thereon. The resistive coating 30 should have adhesive properties for the insulating spacers 16. The resistive coating 30 may be applied over portions of each surface of the insulating spacers 16.

The resistive coating 30 functions to reduce electrostatic charging while maintaining the field potential between the cathode 10 and the screen 18. Such coatings that exhibit a surface resistivity in the range of about 10¹⁰ ohms/square to about 10¹⁵ ohms/square are sufficient for reducing electrostatic charging of the spacer surfaces.

The resistive coating 30 may comprise a metal oxide mixed with at least one silicate glass. A dispersant may optionally be added to the resistive coating. The amount of the metal oxide in the resistive coating is used to control the resistivity thereof.

Suitable metal oxides may include, for example, chromium oxide, among others. Suitable silicate glasses may include, for example, potassium silicate, sodium silicate, lead-zinc-borosilicate glass, and devitrifying glass, among others.

An exemplary resistive coating may comprise a mixture of 37 weight % chromium oxide powder, 2 weight % dispersant, 11 weight % sodium silicate and 20 weight % potassium silicate in about 30 weight % deionized water. The resistive coating mixture is milled in a ball mill to achieve a homogeneous mixture suitable for application onto the insulating spacers 16.

According to one embodiment of the invention, the resistive coating mixture is applied to the insulating spacers 16, e.g., by spraying. The resistive coating 30 preferably has a thickness of about 0.05 mm to about 0.09 mm (2-3.5 mils).

The insulating spacers 16, having the resistive coating 30 thereon, is dried at room temperature. After drying, the resistive coating 30 on the insulating spacers 16 is hardened (cured) by heating the spacers 16 in an oven. The spacers 16 are heated over a period of about 30 minutes to a temperature of about 300° C., and held at 300° C., for about 20 minutes. Then, over a period of 20 minutes, the temperature of the oven is increased to about 460° C., and held at that temperature for two hours to melt and crystallize the coating and form a resistive layer on the insulating spacers 16. The resistive coating 30, after firing, will typically not remelt.

Although an exemplary luminescent screen for a carbon nanotube (CNT)/field emission display (FED) which incorporates the teachings of the present invention has been shown and described in detail herein, those skilled in the art can readily devise many other varied embodiments that still incorporate these teachings.

1. A display, comprising:
a screen separated from a cathode with a plurality of spacers; wherein one or more of the plurality of spacers have a resistive coating thereon including a metal oxide and at least one silicate.

2. The display of claim 1 wherein the metal oxide is chromium oxide.

3. The display of claim 1 wherein the at least one silicate is selected from the group consisting of potassium silicate, sodium silicate, lead-zinc-borosilicate glass, and devitrifying glass.

4. The display of claim 1 wherein the resistive coating has a thickness of about 0.05 mm to about 0.09 mm.

5. The display of claim 1 wherein the resistive coating has a surface resistivity within a range of about 10¹⁰ ohms/square to about 10¹⁵ ohms/square.

6. A carbon nanotube/field emission display, comprising:
a screen separated from a cathode with a plurality of spacers; wherein one or more of the plurality of spacers have a resistive coating thereon including a metal oxide and at least one silicate.

7. The carbon nanotube/field emission display of claim 6 wherein the metal oxide is chromium oxide.

8. The carbon nanotube/field emission display of claim 6 wherein the at least one silicate is selected from the group consisting of potassium silicate, sodium silicate, lead-zinc-borosilicate glass, and devitrifying glass.

9. The carbon nanotube/field emission display of claim 6 wherein the resistive coating has a thickness of about 0.05 mm to about 0.09 mm.

10. The carbon nanotube/field emission display of claim 6 wherein the resistive coating has a surface resistivity within a range of about 10¹⁰ ohms/square to about 10¹⁵ ohms/square.
